(19) United States
(12) Patent Application Publication
(10) Pub. No.: US 2023/0278929 A1
(43) Pub. Date: Sep. 7, 2023

(54) COMPOSITE SINTERED BODY, HONEYCOMB STRUCTURE, ELECTRICALLY HEATING CATALYST, AND METHOD OF MANUFACTURING COMPOSITE SINTERED BODY

(71) Applicant: NGK Insulators, Ltd., Nagoya-City (JP)

(72) Inventors: Kazuya HOSODA, Toyoake-City (JP); Kyohei ATSUJI, Nagoya-City (JP); Kisuke YAMAMOTO, Kuwana-City (JP); Takahiro TOMITA, Chita-City (JP)

(73) Assignee: NGK Insulators, Ltd., Nagoya-City (JP)

(21) Appl. No.: 18/162,800

(22) Filed: Feb. 1, 2023

(30) Foreign Application Priority Data
Mar. 4, 2022 (JP) 2022-033527

(51) Int. Cl. C04B 35/195; C04B 38/00

(52) U.S. Cl. CPC C04B 35/195; C04B 38/0006; C04B 2235/96; C04B 2235/428; C04B 2235/3481; C04B 2235/5436

(57) ABSTRACT

A composite sintered body contains a silicon phase and a cordierite phase. In the composite sintered body, I1/(I1+I2) is not smaller than 0.70 and not larger than 0.80, where I1 and I2 represent peak intensities of a (111) plane of silicon and a (110) plane of cordierite, respectively, which are obtained by the X-ray diffraction method. Further, in the composite sintered body, a median diameter of silicon particles, based on a volume standard, is not smaller than 9 μm.

### CROSS REFERENCE TO RELATED APPLICATION

The present application claims the benefit of priority to Japanese Patent Application No. 2022-033527 filed on Mar. 4, 2022, the content of which is incorporated herein by reference in its entirety.

### TECHNICAL FIELD

The present invention relates to a composite sintered body and a method of manufacturing the same, a honeycomb structure including the composite sintered body, and an electrically heating catalyst including the honeycomb structure.

### BACKGROUND ART

Conventionally, in order to perform a purification treatment of toxic substances such as HC, CO, NOx, or the like contained in exhaust gas discharged from an engine of an automobile or the like, a catalytic converter having a columnar honeycomb structure or the like which supports a catalyst has been used. In the catalytic converter, the temperature of the catalyst needs to rise to an activation temperature in the purification treatment of exhaust gas, but since the temperature of the catalytic converter is low immediately after startup of the engine, or so on, there is a possibility that the exhaust gas purification performance may be reduced. Especially, in a plug-in hybrid electrical vehicle (PHEV) or a hybrid vehicle (HV), since the vehicle runs on motor only, the temperature of the catalyst easily decreases. Then, used is an electrically heating catalyst (EHC) in which a conductive catalytic converter is connected to a pair of electrodes and causes itself to generate heat by energization, to thereby preheat the catalyst.

Japanese Patent Application Laid-Open No. 2020-161413 (Document 1) discloses a technique for the honeycomb structure used in the electrically heating catalyst, in which surface bonding of silicon particles in an electrical resistance body forming the honeycomb structure is performed and a matrix containing borosilicate and cordierite is provided around the continuous body of the silicon particles. It is thereby possible to suppress an increase in the electric resistance (in other words, to improve the oxidation resistance) in the case where the honeycomb structure is exposed to a high temperature oxidation atmosphere.

Furthermore, in the honeycomb structure disclosed in Document 1, since a potion in which the silicon particles are continuous is a local microstructure, it is thought that variation in the volume resistivity for all portions of the honeycomb structure is large and there is a limit in the improvement in the oxidation resistance. It is thought that this local microstructure is caused by inhibiting sintering of the silicon particles by borosilicate. Further, since the honeycomb structure contains borosilicate, sintering shrinkage becomes large and it is difficult to form the honeycomb structure with high dimensional accuracy.

### SUMMARY OF THE INVENTION

The present invention is intended for a composite sintered body, and it is an object of the present invention to improve the oxidation resistance and the thermal shock resistance of a composite sintered body.

The composite sintered body according to one preferred embodiment of the present invention contains a silicon phase and a cordierite phase. In the composite sintered body, I1/+I2) is not smaller than 0.70 and not larger than 0.80, where I1 and I2 represent peak intensities of a (111) plane of silicon and a (110) plane of cordierite, respectively, which are obtained by the X-ray diffraction method. In the composite sintered body, a median diameter of silicon particles, based on a volume standard, is not smaller than 9 μm.

According to the present invention, it is possible to improve the oxidation resistance and the thermal shock resistance of the composite sintered body.

Preferably, a value obtained by dividing a quotient of a strength of the composite sintered body divided by a Young's modulus, by a thermal expansion coefficient, is not smaller than 2.0×10² K.

Preferably, a porosity of the composite sintered body is not lower than 30% and not higher than 50%.

Preferably, an average pore diameter of the composite sintered body is not smaller than 2.5 μm and not larger than 4.0 μm.

Preferably, a volume resistivity of the composite sintered body at 20° C. is not lower than 1.0 Ω·cm and not higher than 100 Ω·cm.

Preferably, a change rate of a volume resistivity of a composite sintered body after exposing the composite sintered body to an atmosphere at 950° C. for 50 hours is not higher than 100%.

The present invention is also intended for a honeycomb structure. The honeycomb structure according to one preferred embodiment of the present invention includes a cylindrical outer wall and a lattice partition wall partitioning an inside of the outer wall into a plurality of cells. The outer wall and the partition wall are formed, including the above-described composite sintered body.

The present invention is still also intended for an electrically heating catalyst used for performing a purification treatment of exhaust gas discharged from an engine. The electrically heating catalyst according to one preferred embodiment of the present invention includes the above-described honeycomb structure and a pair of electrode terminals fixed to an outer surface of the honeycomb structure, for giving a current to the honeycomb structure.

The present invention is yet also intended for a method of manufacturing a composite sintered body. The method of manufacturing a composite sintered body according to one preferred embodiment of the present invention includes a) obtaining a green body by molding raw material powder containing a silicon raw material and a cordierite raw material and b) obtaining a composite sintered body by sintering the green body. The composite sintered body contains a silicon phase and a cordierite phase. In the composite sintered body, I1/+I2) is not smaller than 0.70 and not larger than 0.80, where I1 and I2 represent peak intensities of a (111) plane of silicon and a (110) plane of cordierite, respectively, which are obtained by the X-ray diffraction method. In the composite sintered body, a median diameter of silicon particles, based on a volume standard, is not smaller than 9 μm.

Preferably, a sintering shrinkage of the composite sintered body to the green body is not higher than 10%.

Preferably, a median diameter of the silicon raw material, based on a volume standard, is not smaller than 5 μm.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a cross section showing an electrically heating catalyst in accordance with one preferred embodiment;

FIG. 2 is a flowchart showing an operation flow for manufacturing a honeycomb structure;

FIG. 3 is a SEM image of a honeycomb structure in Example; and

FIG. 4 is a SEM image of a honeycomb structure in Comparative Example.

### DETAILED DESCRIPTION

FIG. 1 is a cross section showing an electrically heating catalyst (EHC) in accordance with one preferred embodiment of the present invention. The electrically heating catalyst 1 is a columnar member which is long in one direction, and FIG. 1 shows a cross section perpendicular to a longitudinal direction of the electrically heating catalyst 1. The electrically heating catalyst 1 is used to perform a purification treatment of exhaust gas discharged from an engine of an automobile or the like.

The electrically heating catalyst 1 includes a honeycomb structure 2, a pair of electrode layers 31, and a pair of electrode terminals 41. The honeycomb structure 2, the pair of electrode layers 31, and the pair of electrode terminals 41 are each conductive. The honeycomb structure 2 is a substantially columnar member having a honeycomb construction, and is a carrier supporting a catalyst in the electrically heating catalyst 1. The pair of electrode layers 31 are fixed on an outer surface of the honeycomb structure 2. The pair of electrode layers 31 are foil-like or plate-like members which are arranged, facing each other with a central axis J1 sandwiched therebetween. The central axis J1 extends in a longitudinal direction of the honeycomb structure 2. Each of the electrode layers 31 is provided along the outer surface of the honeycomb structure 2. Further, in the electrically heating catalyst 1, the outer shape of the honeycomb structure 2 is not limited to the substantially columnar shape but may be changed into any one of various shapes. Furthermore, the respective numbers of and the arrangement of the electrode layers 31 and the electrode terminals 41 may be variously changed. In the electrically heating catalyst 1, the electrode layer 31 may be omitted and the electrode terminal 41 may be directly fixed to the honeycomb structure 2.

The pair of electrode terminals 41 are fixed on surfaces of the pair of electrode layers 31, respectively, by using a junction part 42. In other words, the pair of electrode terminals 41 are indirectly fixed on the outer surface of the honeycomb structure 2 with the pair of electrode layers 31 interposed therebetween. The electrode terminal 41 is, for example, a substantially strip-like member. The electrode terminal 41 is connected to a not-shown power supply. When the power supply applies a voltage across the pair of electrode layers 31 through the electrode terminals 41, a current flows in (in other words, a current is given to) the honeycomb structure 2 and the honeycomb structure 2 generates heat by the Joule heat. The catalyst supported by the honeycomb structure 2 is thereby preheated. The voltage applied to the electrically heating catalyst 1 ranges, for example, from 12 V to 900 V, and preferably ranges from 64 V to 600 V. Further, the voltage may be changed as appropriate.

The honeycomb structure 2 is a cell structure which is partitioned into a plurality of cells 23 inside. The honeycomb structure 2 includes an outer wall 21 and a partition wall 22. The outer wall 21 is a cylindrical portion extending in the longitudinal direction (i.e., the direction perpendicular to this paper of FIG. 1). A cross-sectional shape of the outer wall 21 which is perpendicular to the longitudinal direction is substantially circular. The cross-sectional shape may be any other shape such as an elliptical shape, a polygonal shape, or the like. The honeycomb structure 2 may be used for any use (e.g., a ceramic heater) other than the above-described electrically heating catalyst.

The partition wall 22 is provided inside the outer wall 21 and is a lattice member partitioning the inside thereof into the plurality of cells 23. Each of the plurality of cells 23 is a space extending over substantially the full length of the honeycomb structure 2 in the longitudinal direction. Each cell 23 is a flow passage in which the exhaust gas flows, and the catalyst used for the purification treatment of the exhaust gas is supported by the partition wall 22. A cross-sectional shape of each cell 23 which is perpendicular to the longitudinal direction is, for example, a substantial rectangle. The cross-sectional shape may be any other shape such as a polygonal shape, a circular shape, or the like. In terms of reduction in the pressure loss in the flow of the exhaust gas in the cell 23, it is preferable that the cross-sectional shape should be a quadrangle or a hexagon. Further, in terms of an increase in the structural strength and the uniformity of heating in the honeycomb structure 2, it is preferable that the cross-sectional shape should be a rectangle. The plurality of cells 23 have the same cross-sectional shape in principle. The plurality of cells 23 may include some cells 23 each having a different cross-sectional shape.

The length of the outer wall 21 in the longitudinal direction is, for example, 30 mm to 200 mm. The outer diameter of the outer wall 21 is, for example, 25 mm to 120 mm. In terms of an increase in the heat resistance of the honeycomb structure 2, the area of an end surface of the honeycomb structure 2 (i.e., the area of a region surrounded by the outer wall 21 in the end surface of the honeycomb structure 2) is preferably 2000 mm² to 20000 mm², and further preferably 5000 mm² to 15000 mm². In terms of prevention of outflow of a fluid flowing in the cell 23, an increase in the strength of the honeycomb structure 2, and the strength balance between the outer wall 21 and the partition wall 22, the thickness of the outer wall 21 is, for example, 0.1 mm to 1.0 mm, preferably 0.15 mm to 0.7 mm, and more preferably 0.2 mm to 0.5 mm.

The length of the partition wall 22 in the longitudinal direction is substantially the same as that of the outer wall 21. In terms of an increase in the strength of the honeycomb structure 2 and reduction in the pressure loss in the flow of the exhaust gas in the cell 23, the thickness of the partition wall 22 is, for example, 0.07 mm to 0.3 mm and preferably 0.1 mm to 0.25 mm.

In terms of an increase in the area of the partition wall 22 which supports the catalyst and reduction in the pressure loss in the flow of the exhaust gas in the cell 23, the cell density of the honeycomb structure 2 (i.e., the number of cells 23 per unit area in the cross section perpendicular to the longitudinal direction) is, for example, 40 cells/cm² to 150 cells/cm², and preferably 70 cells/cm² to 100 cells/cm′. The cell density can be obtained by dividing the number of all cells in the honeycomb structure 2 by the area of a region inside an inner peripheral edge of the outer wall 21 in the bottom surface of the honeycomb structure 2. The size of the cell 23, the number of cells 23, the cell density, and the like may be changed in various manners.

The outer wall 21 and the partition wall 22 in the honeycomb structure 2 are formed, including the composite sintered body described below. In the present preferred embodiment, the outer wall 21 and the partition wall 22 are formed of substantially only the composite sintered body.

The composite sintered body is porous ceramics containing a silicon phase and a cordierite phase. In the present specification, the “silicon phase” refers to a crystal phase formed mainly of silicon (Si). The silicon phase may contain impurities other than silicon (for example, a metal other than silicon). The content of impurities is not higher than 1 part by mass with respect to 100 parts by mass of silicon. Further, “silicon” refers to a (simple) substance formed of silicon element. The silicon phase contains a plurality of silicon particles serving as an aggregate of the composite sintered body. In the composite sintered body, the plurality of silicon particles become continuous, to thereby form a conductive path. Further, the composite sintered body may be used for any structure other than the honeycomb structure 2. For example, a structure having any one of various shapes, such as a substantially cylindrical shape, a substantially flat plate-like shape, or the like, may be formed, including the composite sintered body.

In the present specification, the “cordierite phase” refers to a crystal phase formed mainly of cordierite. The cordierite phase may contain impurities other than cordierite. As the impurity, for example, used is indialite which is a polymorph (also referred to as “polymorphism”) of cordierite. The cordierite phase exists mainly among a plurality of silicon particles and is a binder (i.e., a matrix) for binding the plurality of silicon particles. In the composite sintered body, it is preferable that the plurality of silicon particles should be so bound by the cordierite phase as to form a pore among the silicon particles. In the composite sintered body, since the cordierite phase having a relatively low thermal expansion coefficient is contained, the thermal shock resistance of the composite sintered body is improved.

The composite sintered body may further contain an amorphous phase. The amorphous phase is a phase of amorphous substance containing, for example, silicon, and the amorphous phase is an oxide phase formed mainly of amorphous silica (i.e., amorphous silicon dioxide (SiO₂)). The amorphous phase exists mainly on surfaces of the silicon particles and partially or entirely coats the silicon particles. Even in a case where the composite sintered body is exposed to a high temperature oxidation atmosphere, oxidation of the silicon particles is thereby suppressed and a change in the volume resistivity of the composite sintered body is suppressed. In other words, the oxidation resistance of the composite sintered body is improved. Amorphous silica contained in the amorphous phase is generated by, for example, oxidizing the surfaces of the silicon particles. Further, the amorphous phase may contain an oxide other than amorphous silica and/or any amorphous substance other than an oxide.

The composite sintered body may further contain a cristobalite phase. In the present specification, the “cristobalite phase” refers to a crystal phase formed mainly of cristobalite. The cristobalite phase may contain impurities other than cristobalite. The cristobalite phase exists, for example, on the surfaces of the silicon particles, a surface and an inside of a film of the amorphous phase coating the silicon particles, and the like. The cristobalite phase is generated by, for example, oxidizing the surfaces of the silicon particles.

The composite sintered body may further contain a mullite phase. In the present specification, the “mullite phase” refers to a crystal phase formed mainly of mullite. The mullite phase may contain impurities other than mullite. The mullite phase exists, for example, on the surfaces of the silicon particles, the surface and the inside of the film of the amorphous phase coating the silicon particles, and the like. The mullite phase is generated by, for example, reaction firing or the like using and consuming cristobalite as a material, which is generated by oxidizing the surfaces of the silicon particles. The denseness of the composite sintered body is thereby increased, and the oxidation resistance and the strength of the composite sintered body are increased. Further, since the thermal expansion coefficient of the composite sintered body is reduced by reduction of the cristobalite phase, the thermal shock resistance of the composite sintered body is also improved.

The respective contents of the silicon phase and the cordierite phase in the composite sintered body can be determined by using the respective peak intensities (i.e., peak tops) of silicon and cordierite, which are obtained by the X-ray diffraction method (XRD). In the following description, I1 represents the peak intensity of a (111) plane of silicon and I2 represents the peak intensity of a (110) plane of cordierite. “I1/(I1+I2)” representing the peak ratio between silicon and cordierite is not smaller than 0.70 and not larger than 0.80. When I1/(I1+I2) is made not smaller than 0.70, since the content of the silicon phase forming the conductive path becomes higher than a certain degree, the volume resistivity of the composite sintered body is reduced. Further, the oxidation resistance of the composite sintered body is improved, and even in the case where the composite sintered body is exposed to the high temperature oxidation atmosphere, a change in the volume resistivity of the composite sintered body is suppressed. When I1/+I2) is made not larger than 0.80, since the content of the cordierite phase having a low thermal expansion coefficient becomes higher than a certain degree, the thermal expansion coefficient of the composite sintered body is reduced and the thermal shock resistance of the composite sintered body is improved. I1/(I1+I2) is preferably not smaller than 0.71, and more preferably not smaller than 0.72. Further, I1/(I1+I2) is more preferably not larger than 0.75.

In the composite sintered body, the average particle diameter of the silicon particles in the silicon phase is preferably not smaller than 9 and more preferably not smaller than 10 The upper limit of the average particle diameter of the silicon particles is not particularly limited, but is preferably not larger than 30 and more preferably not larger than 20 In the present specification, the “average particle diameter” refers to a median diameter (D₅₀) based on a volume standard, unless otherwise specified.

In the present specification, the average particle diameter of the silicon particles in the composite sintered body is obtained as follows. First, an arbitrary polished cross section of the composite sintered body is observed by a SEM (scanning electron microscope) at an arbitrary magnification (for example, 500 times) and one silicon particle within the field of view is extracted. Subsequently, the long and short diameters of this silicon particle are obtained. Specifically, two points on the outer circumference of the silicon particle are connected and the longest diameter passing the barycenter is obtained as the long diameter. Further, two points on the outer circumference of the silicon particle are connected and the shortest diameter passing the barycenter is obtained as the short diameter. For the measurement of the long and short diameters, for example, the image analysis software “Image Pro 9” of Media Cybernetics, Inc. can be used. Then, the arithmetic average of the long and short diameters is obtained as the particle diameter of the silicon particle. Furthermore, also with respect to the plurality of other silicon particles within the above-described field of view, respective particle diameters thereof are obtained by the same method. Then, the respective particle diameters obtained with respect to the plurality of silicon particles within the above-described field of view are volume-converted, and the particle diameter whose cumulative value of the volume is 50% is obtained as the median diameter (D₅₀) of the silicon particles, based on the volume standard.

Next, the position of the field of view in the above-described polished cross section of the composite sintered body is changed, the particle diameter of each silicon particle included within the field of view is obtained by the same method as above, and the median diameter (D₅₀) of the silicon particles, based on the volume standard is thereby obtained. Then, in each of a predetermined number (2 or more, for example, 3) of fields of view on the above-described cross section of the composite sintered body, an arithmetic average of the above-described D₅₀ of the silicon particles obtained, respectively, is obtained as the average particle diameter of the silicon particles in the composite sintered body. The average particle diameter of other particles (for example, the cordierite particles) in the composite sintered body can be obtained by the same method.

The volume resistivity of the composite sintered body at 20° C. is preferably not lower than 1.0 Ω·cm, more preferably not lower than 3.0 Ω·cm, and further preferably not lower than 10 Ω·cm. Further, the volume resistivity is preferably not higher than 100 Ω·cm, and more preferably not higher than 50 Ω·cm. In the present specification, the “volume resistivity” refers to a volume resistivity at 20° C., unless otherwise specified. When the volume resistivity of the composite sintered body is made not higher than 100 Ω·cm, the electrical conductivity of the electrically heating catalyst 1 is increased and a quick rise of the temperature of the electrically heating catalyst 1 is achieved. Further, when the volume resistivity of the composite sintered body is made not lower than 1.0 Ω·cm, even in a case where a relatively high voltage is applied to the composite sintered body, damage of an electric circuit due to excessive current flow is prevented. The volume resistivity can be measured by the four-probe (four-terminal) method (JIS C2525).

The change rate of the volume resistivity of the composite sintered body after exposing the composite sintered body to an atmosphere at 950° C., which is a high temperature oxidation atmosphere, for 50 hours (in other words, the change rate of the volume resistivity of the composite sintered body after exposure, which is hereinafter referred to as a “resistance change rate”) is preferably not higher than 100%. The resistance change rate is a result expressed by percentage, which is obtained by subtracting 1 from a value obtained by dividing the volume resistivity of the composite sintered body after the exposure thereof in the atmosphere at 950° C. for 50 hours by the volume resistivity (hereinafter, also referred to as “initial resistivity”) of the composite sintered body before the exposure. In the present specification, the “resistance change rate” refers to the change rate of the volume resistivity of the composite sintered body after the exposure in the atmosphere at 950° C. for 50 hours, unless otherwise specified.

When the resistance change rate of the composite sintered body is made not higher than 100%, even in the case where the composite sintered body is exposed to the high temperature oxidation atmosphere, the change in the volume resistivity of the composite sintered body is suitably suppressed and the composite sintered body having still higher oxidation resistance can be provided. Various performances such as the energization performance and the like of the electrically heating catalyst 1 can be thereby kept within a desirable range. The resistance change rate of the composite sintered body is more preferably not higher than 50%. Further, there is a possibility that the volume resistivity of the composite sintered body may be reduced by the effects of the impurities contained in the silicon particles, and the like. In this case, the resistance change rate is preferably not lower than−50%, and more preferably not lower than−10%. Since it is desirable that the volume resistivity of the composite sintered body should not be changed, it is desirable that the resistance change rate should be closer to 0%.

The porosity of the composite sintered body is preferably not lower than 30%, and more preferably not lower than 35%. Further, the porosity thereof is preferably not higher than 50%, and more preferably not higher than 45%. When the porosity is made not lower than 30%, it is possible to reduce the Young's modulus of the composite sintered body and improve the thermal shock resistance thereof. Furthermore, when the porosity is made not higher than 50%, the denseness of the composite sintered body is improved. As a result, the volume resistivity of the composite sintered body is reduced and the oxidation resistance and the strength of the composite sintered body are increased. The porosity can be measured, for example, by the mercury porosimetry (mercury intrusion porosimetry) (JIS R1655) using a mercury porosimeter or the like.

The average pore diameter of the composite sintered body is preferably not smaller than 2.5 more preferably not smaller than 2.7 and further preferably not smaller than 3.0 Further, the average pore diameter thereof is preferably not larger than 4.0 μm, and more preferably not larger than 3.5 μm. When the average pore diameter is made not smaller than 2.5 μm, it is thereby possible to prevent the specific surface area of the composite sintered body becoming excessively large, resulting in a reduction in the oxidation resistance. Further, when the average pore diameter is made not larger than 4.0 μm, the denseness of the composite sintered body is improved. As a result, the volume resistivity of the composite sintered body is reduced and the oxidation resistance and the strength of the composite sintered body are increased. In the present specification, the “average pore diameter” refers to the average pore diameter of the composite sintered body. The average pore diameter can be measured, for example, by the mercury porosimetry (mercury intrusion porosimetry) (JIS R1655) using the mercury porosimeter or the like.

In the present specification, a coefficient “Cs” indicating the thermal shock resistance of the composite sintered body is obtained as follows. First, the strength, the Young's modulus, and the thermal expansion coefficient of the composite sintered body are obtained. The strength of the composite sintered body can be measured by a four-point bending test (in conformity with JIS R1601). The Young's modulus of the composite sintered body can be measured by dynamic elastic modulus measurement (in conformity with JIS R1602). As to the thermal expansion coefficient of the composite sintered body, a linear thermal expansion coefficient at 25° C. to 800° C., which is measured by a method in conformity with JIS R1618 is adopted as its value. The above-described coefficient Cs is obtained by dividing a value of the strength of the composite sintered body divided by the Young's modulus by the thermal expansion coefficient. As the coefficient Cs becomes larger, the thermal shock resistance of the composite sintered body is increased. The coefficient Cs is preferably not smaller than 2.0×10² K, and more preferably not smaller than 2.5×10² K. When the coefficient Cs is made not smaller than 2.0×10² K, the thermal shock resistance of the composite sintered body can be further improved. The upper limit of the coefficient Cs is not particularly limited, but is preferably not higher than 6.0×10² K.

The electrode layer 31 extends in the longitudinal direction along the outer surface of the honeycomb structure 2 and spreads in a circumferential direction around the central axis J1 (hereinafter, also referred to simply as a “circumferential direction”). The electrode layer 31 spreads the current from the electrode terminal 41 in the longitudinal direction and the circumferential direction, to thereby increase the uniformity of heat generation of the honeycomb structure 2. The length of the electrode layer 31 in the longitudinal direction is, for example, 80% or more of the length of the honeycomb structure 2 in the longitudinal direction, and preferably 90% or more. More preferably, the electrode layer 31 extends over the full length of the honeycomb structure 2.

The angle of the electrode layer 31 in the circumferential direction (i.e., an angle formed by two line segments extending from both ends of the electrode layer 31 in the circumferential direction to the central axis J1) is, for example, 30° or more, preferably 40° or more, and more preferably 60° or more. On the other hand, in terms of suppressing the current flowing inside the honeycomb structure 2 from decreasing due to the pair of electrode layers 31 which are too close to each other, the angle of the electrode layer 31 in the circumferential direction is, for example, 140° or less, preferably 130° or less, and more preferably 120° or less.

In the exemplary case shown in FIG. 1, though the angle between centers of the pair of electrode layers 31 in the circumferential direction (i.e., the angle not larger than 180°, which is formed by two line segments extending from the respective centers of the two electrode layers 31 in the circumferential direction to the central axis J1 in FIG. 1) is 180°, this angle may be changed as appropriate. The angle is, for example, 150° or more, preferably 160° or more, and more preferably 170° or more.

In terms of preventing the electric resistance from becoming excessively high and preventing any breakage in a case where the honeycomb structure 2 is put into a container (i.e., in canning), the thickness of the electrode layer 31 (i.e., the thickness in the radial direction) is, for example, 0.01 mm to 5 mm, and preferably 0.01 mm to 3 mm.

It is preferable that the volume resistivity of the electrode layer 31 should be lower than that of the honeycomb structure 2. The current thereby becomes easier to flow to the electrode layer 31 than to the honeycomb structure 2, and the current becomes easier to be spread in the longitudinal direction and the circumferential direction of the honeycomb structure 2. It is preferable that the volume resistivity of the electrode layer 31 should be not lower than one two-hundredth of that of the honeycomb structure 2 and not higher than one tenth thereof.

The electrode layer 31 is formed of, for example, conductive ceramics, a metal, or a composite material of the conductive ceramics and the metal. The conductive ceramics is, for example, silicon carbide (SiC) or a metal silicide such as tantalum silicide (TaSi₂), chromium silicide (CrSi₂), or the like. The metal is, for example, chromium (Cr), iron (Fe), cobalt (Co), nickel (Ni), silicon, or titanium (Ti). In terms of reduction in the thermal expansion coefficient, the material of the electrode layer 31 may be a composite material in which alumina, mullite, zirconia, cordierite, silicon nitride, aluminum nitride, or the like is added to one kind of or two or more kinds of metals.

It is preferable that the material of the electrode layer 31 should be a material which can be sintered at the same time as the honeycomb structure 2 is sintered. In terms of compatibility between the heat resistance and the conductivity, the material of the electrode layer 31 is preferably ceramics whose main component (specifically, containing 90 mass % or more) is silicon carbide or a silicon-silicon carbide (Si—SiC) composite material, and more preferably silicon carbide or a silicon-silicon carbide composite material. The silicon-silicon carbide composite material contains silicon carbide particles as an aggregate and silicon as a binder for binding the silicon carbide particles, and it is preferable that a plurality of silicon carbide particles should be so bound by silicon as to form a pore among the silicon carbide particles.

The electrode terminal 41 is formed of, for example, a simple metal or an alloy. In terms of having high corrosion resistance and appropriate volume resistivity and thermal expansion coefficient, the material of the electrode terminal 41 is preferably an alloy containing at least one kind of Cr, Fe, Co, Ni, Ti, and aluminum (Al). The electrode terminal 41 is preferably stainless steel and more preferably contains Al. Further, the electrode terminal 41 may be formed of a metal-ceramics mixed member. The metal contained in the metal-ceramics mixed member is, for example, a simple metal such as Cr, Fe, Co, Ni, Si, or Ti or an alloy containing at least one kind of metal selected from a group of these metals. The ceramics contained in the metal-ceramics mixed member is, for example, silicon carbide or a metal compound such as metal silicide (e.g., tantalum silicide (TaSi₂) or chromium silicide (CrSi₂)) or the like. As the ceramics, cermet (i.e., a composite material of ceramics and a metal) may be used. The cermet is, for example, a composite material of metallic silicon and silicon carbide, a composite material of metal silicide, metallic silicon, and silicon carbide, or a composite material in which one or more kinds of insulating ceramics such as alumina, mullite, zirconia, cordierite, silicon nitride, aluminum nitride, or the like are added to one or more kinds of the above-described metals.

Each of the junction parts 42 is formed of, for example, a composite material containing a metal and an oxide. The metal is, for example, one or more kinds of stainless steel, a Ni—Fe alloy, and Si. The oxide is one or more kinds of cordierite-based glass, silicon dioxide (SiO₂), aluminum oxide (Al₂O₃), magnesium oxide (MgO), and a composite oxide of these oxides.

The junction part 42 may contain a conductive material other than any metal, instead of the above-described metal or additionally to the above-described metal. The conductive material is, for example, one or more kinds of a boride such as zinc boride, tantalum boride, or the like, a nitride such as titanium nitride, zirconium nitride, or the like, and a carbide such as silicon carbide, tungsten carbide, or the like.

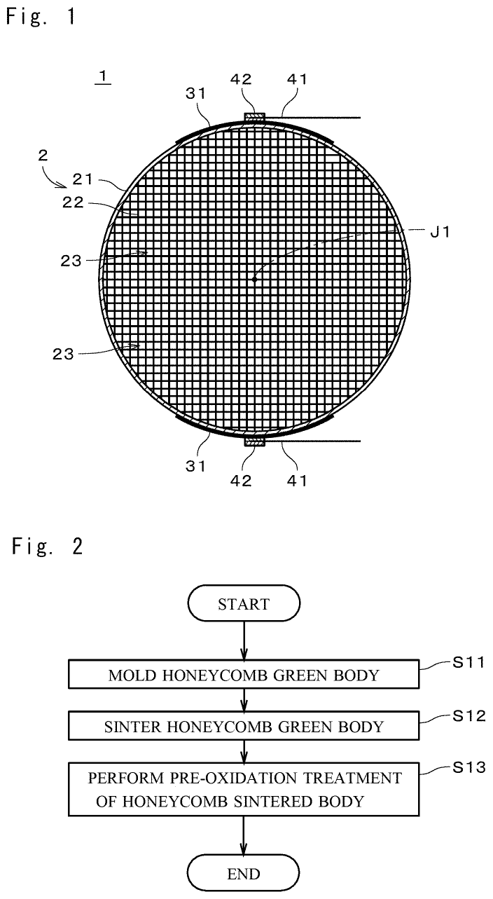

Next, with reference to FIG. 2, an exemplary flow of manufacturing the honeycomb structure 2 will be described. First, raw material powder containing a silicon raw material and a cordierite raw material, a binder, a pore-forming agent, and the like are weighed to have a predetermined composition and dry-mixed by using a dry mixer, to thereby obtain mixed powder. The above-described raw material powder is powder serving as a raw material of a silicon phase and a cordierite phase. The above-described cordierite raw material may be cordierite itself, may be a raw material (for example, one or more kinds of substances selected from kaolin, talc, alumina, silica, magnesia, forsterite, enstatite, and the like) to be used to generate cordierite by a reaction in a sintering process, or may be a mixture of these. The mixing of the above-described raw material powder, the binder, and the like may be performed by wet mixing using a solvent (for example, ion exchange water, an organic solvent, or the like).

To the above-described mixed powder, an aid may be added, additionally to the silicon raw material and the cordierite raw material which are main raw materials. The aid is used in, for example, the above-described generation of the mullite phase from the cristobalite phase. The aid is, for example, a silica-alumina-based aid. As the aid, for example, a mixture of aluminum hydroxide (Al(OH)₃), montmorillonite, and kaolin can be used.

Further, it is preferable that the above-described mixed powder should not contain boron (B). In the manufacture of the composite sintered body, sintering inhibition among the silicon particles due to borosilicate is thereby prevented and variation in the volume resistivity for all portions of the honeycomb structure 2 is suppressed. Furthermore, since sintering shrinkage in the manufacture of the honeycomb structure 2 is reduced, the dimensional accuracy of the honeycomb structure 2 is increased.

As the binder included in the above-described mixed powder, for example, methyl cellulose, hydroxypropoxyl cellulose, hydroxyethyl cellulose, carboxymethyl cellulose, polyvinyl alcohol, or the like can be used. As the pore-forming agent, graphite, flour, starch, phenol resin, polymethylmethacrylate (poly (methyl methacrylate)), polyethylene, polyethylene terephthalate, foaming resin (acrylonitrile plastic balloon), water-absorbing resin, or the like can be used.

Subsequently, the above-described mixed powder, an appropriate amount of water, and the like are kneaded by a kneader, and body paste is produced from the kneaded product which is thereby obtained, by a tug mill (kneading machine). Then, by extrusion-molding the body paste, a green body having a honeycomb construction (hereinafter, also referred to as a “honeycomb green body”) is manufactured (Step S11). Next, microwave drying is performed on the honeycomb green body and then hot-air drying is performed thereon at 100° C. Further, degreasing is performed on the honeycomb green body after the drying, at 200° C. to 1000° C. for 1 to 10 hours in an air atmosphere.

The honeycomb green body after the degreasing is sintered at 1250° C. to 1800° C. (preferably, at 1300° C. to 1750° C.) for 0.5 to 5 hours in an inert gas atmosphere such as an argon (Ar) atmosphere or the like. The honeycomb structure 2 which is a sintered body having a honeycomb construction is thereby manufactured. (Step S12).

After Step S12 is ended, the sintering shrinkage of the honeycomb structure 2 to the honeycomb green body is preferably not higher than 10% and more preferably not higher than 7%. The sintering shrinkage is a result expressed by percentage, which is obtained by subtracting the arithmetic average of a value obtained by dividing the outer diameter of the honeycomb structure 2 after sintering by the outer diameter of the honeycomb structure 2 before sintering and another value obtained by dividing the height of the honeycomb structure 2 after sintering by the height of the honeycomb structure 2 before sintering, from 1.

In the manufacture of the honeycomb structure 2, after the sintering process in Step S12, an oxidation treatment of the honeycomb structure 2 may be performed (Step S13). The oxidation treatment is a preliminary oxidation treatment which is performed before exposing the honeycomb structure 2 to an oxidation atmosphere at the time of use, and is hereinafter also referred to as a “pre-oxidation treatment”. The pre-oxidation treatment is performed by, for example, heating the honeycomb structure 2 at 900° C. to 1300° C. for 0.5 to 20 hours in the air atmosphere. The pre-oxidation treatment is also referred to as “oxidation aging”. Further, the temperature, the time, the atmosphere, and the like in the pre-oxidation treatment may be changed in various manners. Furthermore, the temperature, the time, the atmosphere, and the like in the above-described drying, degreasing, and sintering of the honeycomb green body may be also changed in various manners.

In the manufacture of the honeycomb structure 2, the average particle diameter (in other words, the median diameter (D₅₀) based on the volume standard) of the silicon raw material in the above-described raw material powder is preferably not smaller than 5 and more preferably not smaller than 8 The upper limit of the average particle diameter of the silicon particles in the raw material powder is not particularly limited, but actually, is preferably not larger than 30 and more preferably not larger than 20 It is thereby possible to suitably achieve coarsening of the silicon particles so that the average particle diameter of the silicon particles in the honeycomb structure 2 can be controlled to be, for example, not smaller than 9 As a result, as described above, the volume resistivity of the composite sintered body falls within a favorable range, and the oxidation resistance of the composite sintered body is improved. In the present specification, unless otherwise specified, the average particle diameter of the particles in the raw material powder refers to a value obtained by the particle size distribution measurement performed by the laser diffraction scattering method (JIS R1629).

The electrically heating catalyst 1 is manufactured by fixing the pair of electrode layers 31 and the pair of electrode terminals 41 to the honeycomb structure 2 which is manufactured as described above. In the electrically heating catalyst 1, the catalyst is supported by inner surfaces of the plurality of cells 23 (i.e., a side surface of the partition wall 22) of the honeycomb structure 2. Further, the pair of electrode layers 31 may be formed at the same time as the honeycomb structure 2 is formed, by giving electrode layer paste which is a raw material of the electrode layer 31 to the honeycomb green body which is a precursor of the honeycomb structure 2 and sintering both the honeycomb green body and the electrode layer paste.

As described above, the method of manufacturing a composite sintered body includes a step (Step S11) of obtaining a green body by molding raw material powder containing a silicon raw material and a cordierite raw material and a step (Step S12) of obtaining a composite sintered body by sintering the green body. The composite sintered body contains a silicon phase and a cordierite phase. In the composite sintered body, I1/+I2) is not smaller than 0.70 and not larger than 0.80, where I1 and I2 represent peak intensities of a (111) plane of silicon and a (110) plane of cordierite, respectively, which are obtained by the X-ray diffraction method. Further, in the composite sintered body, the median diameter of silicon particles, based on a volume standard, is not smaller than 9 μm. As described above, it is thereby possible to cause the volume resistivity of the composite sintered body to fall within a favorable range and improve the oxidation resistance of the composite sintered body. Further, it is also possible to improve the thermal shock resistance of the composite sintered body. Moreover, it is also possible to reduce the sintering shrinkage of the composite sintered body.

As described above, it is preferable that the sintering shrinkage of the composite sintered body to the green body should be not higher than 10%. It is thereby possible to manufacture the composite sintered body with high dimensional accuracy. As a result, it is thereby possible to manufacture the honeycomb structure 2 and the electrically heating catalyst 1 with high dimensional accuracy.

Next, with reference to Tables 1 to 5, Examples of the honeycomb structure 2 in accordance with the present invention and Comparative Examples for comparison with the honeycomb structure 2 will be described. Table 1 shows respective manufacturing conditions of the honeycomb structure 2 in Examples and the honeycomb structure in Comparative Examples, and Tables 2 to 5 show respective sintered body properties of the honeycomb structure 2 in Examples and the honeycomb structure in Comparative Examples.

TABLE 1

| | Manufacturing Conditions | | | |
|---|---|---|---|---|
| | Silicon Particle | Composition | | |
| | Diameter | Silicon | Cordierite | Aid |
| | μm | Mass % | Mass % | Parts by Mass |
| Example 1 | 10 | 48 | 52 | 6 |
| Example 2 | 10 | 46 | 54 | 6 |
| Example 3 | 10 | 43 | 57 | 6 |
| Example 4 | 6 | 43 | 57 | 6 |
| Comparative | 2 | 33 | 67 | 6 |
| Example 1 | | | | |
| Comparative | 10 | 38 | 62 | 6 |
| Example 2 | | | | |
| Comparative | 2 | 48 | 52 | 6 |
| Example 3 | | | | |

TABLE 2

| | Sintered Body Properties | |
|---|---|---|
| | | XRD Intensity Ratio |
| | Constituent Phase | I1/(I1 + I2) |
| Example 1 | Silicon, Cordierite, Mullite, | 0.75 |
| | Cristobalite, Amorphous Silica | |
| Example 2 | Silicon, Cordierite, Mullite, | 0.73 |
| | Cristobalite, Amorphous Silica | |
| Example 3 | Silicon, Cordierite, Mullite, | 0.72 |
| | Cristobalite, Amorphous Silica | |
| Example 4 | Silicon, Cordierite, Mullite, | 0.71 |
| | Cristobalite, Amorphous Silica | |
| Comparative | Silicon, Cordierite, Mullite, | 0.64 |
| Example 1 | Cristobalite, Amorphous Silica | |
| Comparative | Silicon, Cordierite, Mullite, | 0.69 |
| Example 2 | Cristobalite, Amorphous Silica | |
| Comparative | Silicon, Cordierite, Mullite, | 0.74 |
| Example 3 | Cristobalite, Amorphous Silica | |

TABLE 3

| | Sintered Body Properties | | |
|---|---|---|---|
| | Silicon Particle | | Pore |
| | Diameter | Porosity | Diameter |
| | μm | % | μm |
| Example 1 | 13.6 | 37.9 | 3.3 |
| Example 2 | 13.1 | 40.4 | 3.2 |
| Example 3 | 12.4 | 39.7 | 3.3 |
| Example 4 | 9.3 | 35.2 | 2.7 |
| Comparative | 7.3 | 31.1 | 2.2 |
| Example 1 | | | |
| Comparative | 12.1 | 36.1 | 2.9 |
| Example 2 | | | |
| Comparative | 7.1 | 24.3 | 1.9 |
| Example 3 | | | |

TABLE 4

| | Sintered Body Properties | | | |
|---|---|---|---|---|
| | | | Thermal | Strength/Young's |
| | | Young's | Expansion | Modulus/Thermal |
| | Strength | Modulus | Coefficient | Expansion Coefficient |
| | Mpa | Gpa | ppm/K | ×10² K |
| Example 1 | 46.5 | 30.1 | 3.5 | 4.4 |
| Example 2 | 46.0 | 31.0 | 3.5 | 4.2 |
| Example 3 | 48.2 | 35.0 | 3.5 | 3.9 |
| Example 4 | 49.1 | 51.0 | 3.4 | 2.8 |
| Comparative | 38.1 | 46.6 | 3.4 | 2.4 |
| Example 1 | | | | |
| Comparative | 50.1 | 41.1 | 3.4 | 3.6 |
| Example 2 | | | | |
| Comparative | 48.1 | 71.4 | 3.8 | 1.8 |
| Example 3 | | | | |

TABLE 5

| | Sintered Body Properties | | |
|---|---|---|---|
| | Volume | Resistance | Sintering |
| | Resistivity | Change Rate | Shrinkage |
| | Q · cm | % | % |
| Example 1 | 4 | 3 | 6.1 |
| Example 2 | 13 | 4 | 6.0 |
| Example 3 | 39 | 4 | 6.0 |
| Example 4 | 21 | 4 | 7.2 |
| Comparative | 16 | 300 | 7.9 |
| Example 1 | | | |
| Comparative | >1000 | — | 6.1 |
| Example 2 | | | |
| Comparative | 0.3 | 11 | 8.6 |
| Example 3 | | | |

In Examples 1 to 4, the honeycomb structure 2 is manufactured by Steps S11 to S13 described above. In Step S11, an aid is added to the main raw material (i.e., the silicon raw material and the cordierite raw material). The aid is a mixture of aluminum hydroxide, montmorillonite, and kaolin and used for generation of the mullite phase from the cristobalite phase. In Step S12, the sintering temperature and the sintering time of the honeycomb green body are 1375° C. and 2 hours, respectively. In Step S13, the pre-oxidation treatment temperature and the pre-oxidation treatment time are 1300° C. and 1 hour, respectively. In Comparative Examples 1 to 3, the honeycomb structure is manufactured by substantially the same manufactured method. In Examples 1 to 4 and Comparative Examples 1 to 3, the average particle diameter (in other words, the median diameter (D₅₀) based on the volume standard) of the silicon particles in the raw material powder, the composition of the silicon raw material and the cordierite raw material, and the like are changed.

The crystal phase among the constituent phases shown in Table 2 is identified by measuring a polished surface of a specimen cut out from the partition wall 22 of the honeycomb structure 2 by using an X-ray diffraction apparatus. As the X-ray diffraction apparatus, used is a sealed-tube X-ray diffraction apparatus (D8-ADVANCE manufactured by Bruker AXS). The measurement conditions are CuKα, 40 kV, and 40 mA, and with a concentration optical system using a primary detector where the divergence slit is 0.3°, the solar slit is 4.1°, the step width is 0.02°, the scan speed is 0.2 s/step, and the sample rotation speed is 15 rpm, measured is 20=5°-70°.

Further, the height (level) of peak (i.e., the peak top) detected at a predetermined angle is defined as peak intensity, and the peak intensity I1 of a (111) plane detected in 20=28.44° of silicon and the peak intensity I2 of a (110) plane detected in 20=10.48° of cordierite are obtained by using the above-described X-ray diffraction apparatus. Furthermore, whether the amorphous phase is present or not is determined by whether there is halo or not in an X-ray diffraction pattern, and the constituent component is detected by EDS (energy dispersive X-ray spectroscopic analysis). The method of determining whether the amorphous phase is present or not is not limited to the above-described method, but whether the amorphous phase is present or not can be also determined from, for example, whether there is halo or not in an electron diffraction pattern obtained by the transmission electron microscope (TEM) or the scanning transmission electron microscope (STEM).

The average particle diameter of the silicon particles in the honeycomb structure 2 shown in Table 3 is obtained by the above-described method. Further, the porosity and the average pore diameter of the honeycomb structure 2 are measured by the mercury porosimetry (mercury intrusion porosimetry) (JIS R1655) using a mercury porosimeter, as described above. The strength, the Young's modulus, and the thermal expansion coefficient of the honeycomb structure 2 shown in Table 4 is obtained by the above-described method, and the coefficient Cs indicating the thermal shock resistance is obtained as “strength/Young's modulus/thermal expansion coefficient” as described above.

The volume resistivity in Table 5 is the above-described initial resistivity and is measured by the four-probe (four-terminal) method (JIS C2525). The resistance change rate is obtained by the above-described method. Specifically, a specimen cut out from the partition wall 22 of the honeycomb structure 2 is exposed in the atmosphere at 950° C. for 50 hours, and then the volume resistivity of the specimen (hereinafter, also referred to as “post-exposure resistivity”) is measured by the four-probe (four-terminal) method. Then, the resistance change rate refers to a result expressed by percentage, which is obtained by subtracting 1 from a value obtained by dividing the post-exposure resistivity by the initial resistivity. Further, the sintering shrinkage is obtained by the above-described method.

In Example 1, as to the silicon raw material and the cordierite raw material which are the main raw materials of the honeycomb structure 2, the average particle diameter of the silicon particles in the raw material powder is 10 μm, and the contents of the silicon raw material and the cordierite raw material in the main raw material are 48 mass % and 52 mass %, respectively. Further, 6 parts by mass of aid is added with respect to 100 parts by mass of the main raw material.

The constituent phases of the honeycomb structure 2 in Example 1 are the silicon phase, the cordierite phase, the mullite phase, the cristobalite phase, and amorphous silica. The peak ratio I1/(I1+I2) between silicon and cordierite is 0.75. The average particle diameter of the silicon particles in the silicon phase of the honeycomb structure 2 is 13.6 μm. The porosity and the average pore diameter of the honeycomb structure 2 are 37.9% and 3.3 μm, respectively. The strength, the Young's modulus, and the thermal expansion coefficient of the honeycomb structure 2 are 46.5 Mpa, 30.1 GPa, and 3.5 ppm/K, respectively. The coefficient Cs indicating the thermal shock resistance of the honeycomb structure 2 is 4.4×10² K. The volume resistivity of the honeycomb structure 2 is 4 Ω·cm. The resistance change rate of the honeycomb structure 2 is 3%. The sintering shrinkage of the honeycomb structure 2 is 6.1%.

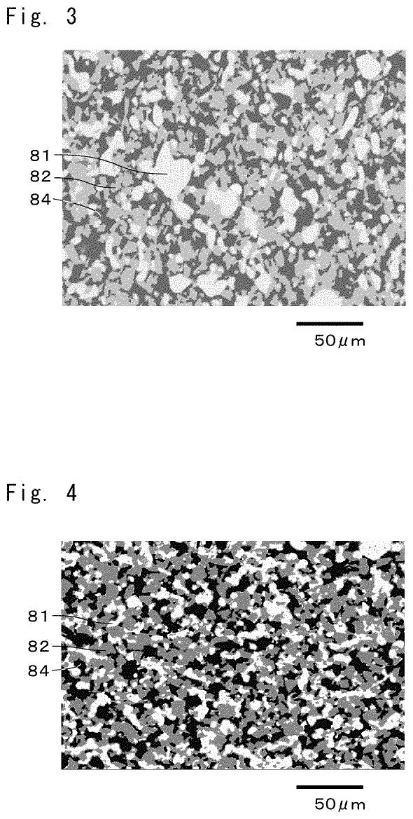

FIG. 3 is a SEM image showing a polished cross section of the honeycomb structure 2 in Example 1. In FIG. 3, a white portion 81 represents silicon and a black portion 84 represents a pore. Further, a gray portion 82 represents cordierite.

In Example 2, the average particle diameter of the silicon particles in the raw material powder is 10 μm, and the contents of the silicon raw material and the cordierite raw material in the main raw material are 46 mass % and 54 mass %, respectively. Further, 6 parts by mass of aid is added with respect to 100 parts by mass of the main raw material.

The constituent phases of the honeycomb structure 2 in Example 2 are the silicon phase, the cordierite phase, the mullite phase, the cristobalite phase, and amorphous silica. The peak ratio I1/(I1+I2) between silicon and cordierite is 0.73. The average particle diameter of the silicon particles in the silicon phase of the honeycomb structure 2 is 13.1 μm. The porosity and the average pore diameter of the honeycomb structure 2 are 40.4% and 3.2 μm, respectively. The strength, the Young's modulus, and the thermal expansion coefficient of the honeycomb structure 2 are 46.0 Mpa, 31.0 GPa, and 3.5 ppm/K, respectively. The coefficient Cs indicating the thermal shock resistance of the honeycomb structure 2 is 4.2×10² K. The volume resistivity of the honeycomb structure 2 is 13 Ω·cm. The resistance change rate of the honeycomb structure 2 is 4%. The sintering shrinkage of the honeycomb structure 2 is 6.0%.

In Example 3, the average particle diameter of the silicon particles in the raw material powder is 10 μm, and the contents of the silicon raw material and the cordierite raw material in the main raw material are 43 mass % and 57 mass %, respectively. Further, 6 parts by mass of aid is added with respect to 100 parts by mass of the main raw material.

The constituent phases of the honeycomb structure 2 in Example 3 are the silicon phase, the cordierite phase, the mullite phase, the cristobalite phase, and amorphous silica. The peak ratio I1/(I1+I2) between silicon and cordierite is 0.72. The average particle diameter of the silicon particles in the silicon phase of the honeycomb structure 2 is 12.4 μm. The porosity and the average pore diameter of the honeycomb structure 2 are 39.7% and 3.3 μm, respectively. The strength, the Young's modulus, and the thermal expansion coefficient of the honeycomb structure 2 are 48.2 Mpa, 35.0 GPa, and 3.5 ppm/K, respectively. The coefficient Cs indicating the thermal shock resistance of the honeycomb structure 2 is 3.9×10² K. The volume resistivity of the honeycomb structure 2 is 39 Ω·cm. The resistance change rate of the honeycomb structure 2 is 4%. The sintering shrinkage of the honeycomb structure 2 is 6.0%.

In Example 4, the average particle diameter of the silicon particles in the raw material powder is 6 μm, and the contents of the silicon raw material and the cordierite raw material in the main raw material are 43 mass % and 57 mass %, respectively. Further, 6 parts by mass of aid is added with respect to 100 parts by mass of the main raw material.

The constituent phases of the honeycomb structure 2 in Example 4 are the silicon phase, the cordierite phase, the mullite phase, the cristobalite phase, and amorphous silica. The peak ratio I1/(I1+I2) between silicon and cordierite is 0.71. The average particle diameter of the silicon particles in the silicon phase of the honeycomb structure 2 is 9.3 μm. The porosity and the average pore diameter of the honeycomb structure 2 are 35.2% and 2.7 μm, respectively. The strength, the Young's modulus, and the thermal expansion coefficient of the honeycomb structure 2 are 49.1 Mpa, 51.0 GPa, and 3.4 ppm/K, respectively. The coefficient Cs indicating the thermal shock resistance of the honeycomb structure 2 is 2.8×10^{2K}. The volume resistivity of the honeycomb structure 2 is 21 Ω·cm. The resistance change rate of the honeycomb structure 2 is 4%. The sintering shrinkage of the honeycomb structure 2 is 7.2%.

In Comparative Example 1, the average particle diameter of the silicon particles in the raw material powder is 2 μm, and the contents of the silicon raw material and the cordierite raw material in the main raw material are 33 mass % and 67 mass %, respectively. Further, 6 parts by mass of aid is added with respect to 100 parts by mass of the main raw material.

The constituent phases of the honeycomb structure in Comparative Example 1 are the silicon phase, the cordierite phase, the mullite phase, the cristobalite phase, and amorphous silica. The peak ratio I1/(I1+I2) between silicon and cordierite is 0.64. The average particle diameter of the silicon particles in the silicon phase of the honeycomb structure is 7.3 μm. The porosity and the average pore diameter of the honeycomb structure are 31.1% and 2.2 μm, respectively. The strength, the Young's modulus, and the thermal expansion coefficient of the honeycomb structure are 38.1 Mpa, 46.6 GPa, and 3.4 ppm/K, respectively. The coefficient Cs indicating the thermal shock resistance of the honeycomb structure is 2.4×10² K. The volume resistivity of the honeycomb structure is 16 Ω·cm. The resistance change rate of the honeycomb structure is 300%. The sintering shrinkage of the honeycomb structure is 7.9%.

FIG. 4 is a SEM image showing a polished cross section of the honeycomb structure in Comparative Example 1. In FIG. 4, a white portion 81 represents silicon and a black portion 84 represents a pore. Further, a gray portion 82 represents cordierite. It can be seen that the average particle diameter of the silicon particles 81 in FIG. 4 is obviously smaller than that of the silicon particles 81 in FIG. 3.

In Comparative Example 2, the average particle diameter of the silicon particles in the raw material powder is 10 μm, and the contents of the silicon raw material and the cordierite raw material in the main raw material are 38 mass % and 62 mass %, respectively. Further, 6 parts by mass of aid is added with respect to 100 parts by mass of the main raw material.

The constituent phases of the honeycomb structure in Comparative Example 2 are the silicon phase, the cordierite phase, the mullite phase, the cristobalite phase, and amorphous silica. The peak ratio I1/(I1+I2) between silicon and cordierite is 0.69. The average particle diameter of the silicon particles in the silicon phase of the honeycomb structure is 12.1 μm. The porosity and the average pore diameter of the honeycomb structure are 36.1% and 2.9 μm, respectively. The strength, the Young's modulus, and the thermal expansion coefficient of the honeycomb structure are 50.1 Mpa, 41.1 GPa, and 3.4 ppm/K, respectively. The coefficient Cs indicating the thermal shock resistance of the honeycomb structure is 3.6×10² K. The volume resistivity of the honeycomb structure is larger than 1000 Ω·cm. Since the volume resistivity of the honeycomb structure is excessively large, the resistance change rate of the honeycomb structure is not measured. The sintering shrinkage of the honeycomb structure is 6.1%.

In Comparative Example 3, the average particle diameter of the silicon particles in the raw material powder is 2 μm, and the contents of the silicon raw material and the cordierite raw material in the main raw material are 48 mass % and 52 mass %, respectively. Further, 6 parts by mass of aid is added with respect to 100 parts by mass of the main raw material.

The constituent phases of the honeycomb structure in Comparative Example 3 are the silicon phase, the cordierite phase, the mullite phase, the cristobalite phase, and amorphous silica. The peak ratio I1/(I1+I2) between silicon and cordierite is 0.74. The average particle diameter of the silicon particles in the silicon phase of the honeycomb structure is 7.1 μm. The porosity and the average pore diameter of the honeycomb structure are 24.3% and 1.9 μm, respectively. The strength, the Young's modulus, and the thermal expansion coefficient of the honeycomb structure are 48.1 Mpa, 71.4 GPa, and 3.8 ppm/K, respectively. The coefficient Cs indicating the thermal shock resistance of the honeycomb structure is 1.8×10² K. The volume resistivity of the honeycomb structure is 0.3 Ω·cm. The resistance change rate of the honeycomb structure is 11%. The sintering shrinkage of the honeycomb structure is 8.6%.

In comparison between Examples 1 to 4 and Comparative Examples 1 to 3, the peak ratio/(I1+I2) between silicon and cordierite in the honeycomb structure 2 of Examples 1 to 4 is not smaller than 0.70 and not larger than 0.80 while the peak ratio I1/(I1+I2) in the honeycomb structure of Comparative Examples 1 and 2 is smaller than 0.70. Further, the average particle diameter of the silicon particles in the honeycomb structure 2 of Examples 1 to 4 is not smaller than 9 μm while the average particle diameter of the silicon particles in the honeycomb structure of Comparative Examples 1 and 3 is small, i.e., smaller than 9μm.

In Examples 1 to 4, when the peak ratio I1/(I1+I2) is made not smaller than 0.70 and not larger than 0.80 and the average particle diameter of the silicon particles in the honeycomb structure 2 is made not smaller than 9 μm, the volume resistivity of the honeycomb structure 2 falls within a favorable range not lower than 1.0 Ω·cm and not higher than 100 Ω·cm and the resistance change rate of the honeycomb structure 2 becomes low, i.e., not higher than 100%. Further, The coefficient Cs indicating the thermal shock resistance of the honeycomb structure 2 is large, i.e., 2.5×10^{2K}. Furthermore, the sintering shrinkage of the honeycomb structure 2 is low, i.e., not higher than 10%. The porosity of the honeycomb structure 2 is not lower than 30% and not higher than 50%, and the average pore diameter of the honeycomb structure 2 is not smaller than 2.5 μm and not larger than 4.0 μm.

On the other hand, in Comparative Example 1, the peak ratio I1/(I1+I2) is smaller than 0.70, and the average particle diameter of the silicon particles in the honeycomb structure is smaller than 9μm. For this reason, the resistance change rate is high, i.e., 300%, and the coefficient Cs indicating the thermal shock resistance is small, i.e., smaller than 2.5×10² K. Further, the average pore diameter is small, i.e., smaller than 2.5 μm. In Comparative Example 2, the peak ratio I1/(I1+I2) is smaller than 0.70. For this reason, the volume resistivity is higher than 1000 Ω·cm. In Comparative Example 3, the average particle diameter of the silicon particles in the honeycomb structure is smaller than 9μm. For this reason, the volume resistivity is low, i.e., lower than 1.0 Ω·cm, and the coefficient Cs indicating the thermal shock resistance is small, i.e., smaller than 2.5×10² K. Further, the porosity is low, i.e., lower than 25%, and the average pore diameter is small, i.e., smaller than 2.5 μm.

In Examples 1 to 4, when the average particle diameter of the silicon raw material in the raw material powder is made not smaller than 5 μm, it is possible to suitably achieve the average particle diameter of the silicon particles in the honeycomb structure 2, which is not smaller than 9 μm. On the other hand, in Comparative Examples 1 and 3, since the average particle diameter of the silicon raw material in the raw material powder is smaller than 5 μm, the average particle diameter of the silicon particles in the honeycomb structure is smaller than 9 μm.

In comparison between Examples 1 to 3 and Example 4, the average particle diameter of the silicon particles in the honeycomb structure 2 of Examples 1 to 3 ranges from 12.4 μm to 13.6 μm while the average particle diameter of the silicon particles in the honeycomb structure 2 of Example 4 is 9.3 μm. Further, the coefficient Cs indicating the thermal shock resistance in the honeycomb structure 2 of Examples 1 to 3 ranges from 3.9×10² K to 4.4×10² K while the coefficient Cs indicating the thermal shock resistance in the honeycomb structure 2 of Example 4 is 2.8×10² K. Therefore, in terms of further improving the thermal shock resistance (for example, the coefficient Cs is made not smaller than 3.0×10² K), it is preferable that the average particle diameter of the silicon particles should be not smaller than 10 μm.

As described above, the composite sintered body contains the silicon phase and the cordierite phase. In the composite sintered body, I1/+I2) is not smaller than 0.70 and not larger than 0.80, where I1 and I2 represent peak intensities of a (111) plane of silicon and a (110) plane of cordierite, respectively, which are obtained by the X-ray diffraction method. Further, in the composite sintered body, the median diameter of the silicon particles, based on a volume standard, is not smaller than 9 Thus, by causing the ratio between silicon and cordierite to fall within an appropriate range and coarsening the silicon particles, it is possible to cause the volume resistivity of the composite sintered body to fall within a favorable range and improve the oxidation resistance of the composite sintered body. Further, it is also possible to improve the thermal shock resistance of the composite sintered body. Moreover, it is also possible to reduce the sintering shrinkage of the composite sintered body.

The configurations in the above-described preferred embodiment and variations may be combined as appropriate only if those do not conflict with one another.

While the invention has been shown and described in detail, the foregoing description is in all aspects illustrative and not restrictive. It is therefore understood that numerous modifications and variations can be devised without departing from the scope of the invention.

### INDUSTRIAL APPLICABILITY

The present invention can be used for the electrically heating catalyst or the like which is used for the purification treatment of exhaust gas from an engine of an automobile or the like.

### REFERENCE SIGNS LIST

1 Electrically heating catalyst
2 Honeycomb structure
21 Outer wall
22 Partition wall
23 Cell
41 Electrode terminal
S11 to S13 Step

1. A composite sintered body, containing:
a silicon phase; and
a cordierite phase,
wherein I1/(I1+I2) is not smaller than 0.70 and not larger than 0.80, where I1 and I2 represent peak intensities of a (111) plane of silicon and a (110) plane of cordierite, respectively, which are obtained by the X-ray diffraction method, and
a median diameter of silicon particles, based on a volume standard, is not smaller than 9 μm.

2. The composite sintered body according to claim 1, wherein
a value obtained by dividing a quotient of a strength of said composite sintered body divided by a Young's modulus, by a thermal expansion coefficient, is not smaller than 2.0×10² K.

3. The composite sintered body according to claim 1, wherein
a porosity of said composite sintered body is not lower than 30% and not higher than 50%.

4. The composite sintered body according to claim 1, wherein
an average pore diameter of said composite sintered body is not smaller than 2.5 μm and not larger than 4.0 μm.

5. The composite sintered body according to claim 1, wherein
a volume resistivity of said composite sintered body at 20° C. is not lower than 1.0 Ω·cm and not higher than 100 Ω·cm.

6. The composite sintered body according to claim 1, wherein
a change rate of a volume resistivity of a composite sintered body after exposing said composite sintered body to an atmosphere at 950° C. for 50 hours is not higher than 100%.

7. A honeycomb structure, comprising:
a cylindrical outer wall; and
a lattice partition wall partitioning an inside of said outer wall into a plurality of cells,
wherein said outer wall and said partition wall are formed, including said composite sintered body according to claim 1.

8. An electrically heating catalyst used for performing a purification treatment of exhaust gas discharged from an engine, comprising:
said honeycomb structure according to claim 7; and
a pair of electrode terminals fixed to an outer surface of said honeycomb structure, for giving a current to said honeycomb structure.

9. A method of manufacturing a composite sintered body, comprising:
a) obtaining a green body by molding raw material powder containing a silicon raw material and a cordierite raw material; and
b) obtaining a composite sintered body by sintering said green body,
wherein said composite sintered body contains
a silicon phase; and
a cordierite phase,
and wherein I1/(I1+I2) is not smaller than 0.70 and not larger than 0.80, where I1 and I2 represent peak intensities of a (111) plane of silicon and a (110) plane of cordierite, respectively, which are obtained by the X-ray diffraction method, in said composite sintered body, and
a median diameter of silicon particles, based on a volume standard, in said composite sintered body is not smaller than 9 μm.

10. The method of manufacturing a composite sintered body according to claim 9, wherein
a sintering shrinkage of said composite sintered body to said green body is not higher than 10%.

11. The method of manufacturing a composite sintered body according to claim 9, wherein
a median diameter of said silicon raw material, based on a volume standard, is not smaller than 5 μm.
